(19) United States
(12) Patent Application Publication
(10) Pub. No.: US 2023/0302590 A1
(43) Pub. Date: Sep. 28, 2023

(54) MANUFACTURING CELLS HAVING MODULAR SUPPORT PLATFORMS

(71) Applicant: Path Robotics, Inc., Columbus, OH (US)

(72) Inventors: Andrew Ryan LIEN, Columbus, OH (US); Mike KALDY, Columbus, OH (US)

(21) Appl. No.: 17/689,829

(22) Filed: Mar. 8, 2022

(51) Int. Cl. B23P 21/00

(52) U.S. Cl. CPC B23P 21/004

(57) ABSTRACT

A transportable manufacturing cell including a robotic arm extending between a base and a terminal end, a tool attached to the terminal end of the robotic arm, a positioner unit including a positioner extending between a base and a connector, the connector configured to secure a workpiece to the positioner, a sensor unit including one or more sensors, a controller configured to control the operation of the robotic arm and the tool attached to the robotic arm, and a support platform assembly including a free-standing first platform and a separate and distinct free-standing second platform, wherein the robotic arm and the sensor unit are each mounted to the first platform and the positioner unit is mounted to the second platform.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Manufacturing or “work” cells may comprise self-contained cellular units including a robot or robotic arm having an instrument or manufacturing tool such as, for example, a welding tool, a cutting tool, a drilling tool, a gripper, etc. connected thereto and which operates or “works” on an object or workpiece secured within the manufacturing cell. These self-contained manufacturing cells provide an avenue through which robotics may be leveraged in manufacturing or fabrication processes. It may be understood that workpieces operated on by the robotic arms of manufacturing cells may vary significantly in shape, size, materials, etc. The manufacturing cell may also include one or more sensors for monitoring the workpiece and/or manufacturing tool attached to the robotic arm, and a control system or controller which controls the operation of the robotic arm and/or manufacturing tool based on feedback received from the one or more sensors of the manufacturing cell. In some applications, the manufacturing cell may include a platform for physically supporting the robotic arm, controller, one or more sensors, and a positioner used to position the workpiece relative to the robotic arm.

### BRIEF SUMMARY OF THE DISCLOSURE

An embodiment of a transportable manufacturing cell comprises a robotic arm extending between a base and a terminal end, a tool attached to the terminal end of the robotic arm, a positioner unit comprising a positioner extending between a base and a connector, the connector configured to secure a workpiece to the positioner, a sensor unit comprising one or more sensors, a controller configured to control the operation of the robotic arm and the tool attached to the robotic arm, and a support platform assembly comprising a free-standing first platform and a separate and distinct free-standing second platform, wherein the robotic arm and the sensor unit are each mounted to the first platform and the positioner unit is mounted to the second platform. In some embodiments, the second platform is separated from the first platform by a predefined gap extending across an interface that extends between the first platform and the second platform. In some embodiments, the first platform comprises a planar support plate having an upper support surface to which the base of the robotic arm is mounted, and the second platform comprises a support plate having an upper support surface to which the base of the base of the positioner is mounted. In certain embodiments, at least one of the first platform comprises a support rail positioned on the upper support surface of the support plate of the first platform, and the second platform comprises a support rail positioned on the upper support surface of the support plate of the second platform. In certain embodiments, the first platform comprises a first plurality of parallel first support tubes each having an opening positioned at an end of the first platform, and the second platform comprises a second plurality of parallel first support tubes each having an opening positioned at an end of the second platform. In some embodiments, the first platform comprises a first plurality of parallel second support tubes each having an opening positioned at an end of the first platform, and wherein each of the first plurality of second support tubes is oriented perpendicular to the first plurality of first support tubes, and the second platform comprises a second plurality of parallel second support tubes each having an opening positioned at an end of the second platform, and wherein each of the second plurality of second support tubes is oriented perpendicular to the second plurality of first support tubes. In some embodiments, the tool comprises a weld head, and the controller is configured to autonomously weld the workpiece using the robotic arm. In certain embodiments, the first platform comprises a first plurality of feet extending from the first platform and a first plurality of vibration dampers located at terminal ends of the first plurality of feet, and the second platform comprises a second plurality of feet extending from the second platform and a second plurality of vibration dampers located at terminal ends of the second plurality of feet. In certain embodiments, a first load path is formed which extends from the robotic arm, through the first platform, and to a floor upon which the manufacturing cell is positioned, wherein the second platform is isolated from the first load path, and a second load path is formed which extends from the positioner unit, through the second platform, and to the floor, wherein the first platform is isolated from the second load path.

An embodiment of a transportable manufacturing cell comprises a robotic arm extending between a base and a terminal end, a tool attached to the terminal end of the robotic arm, a positioner unit comprising a positioner extending between a base and a connector configured to secure a workpiece to the positioner, a sensor unit comprising one or more sensors, a controller configured to control the operation of the robotic arm and the tool attached to the robotic arm, and a support platform assembly comprising a free-standing platform to which at least one of the robotic arm, the sensor unit, and the positioner unit is mounted, the platform comprising a plurality of feet extending from the platform and a plurality of vibration dampers located at terminal ends of the plurality of feet. In some embodiments, each of the plurality of feet comprises an elongate member extending from one of a plurality of receptacles formed in the platform to a terminal end, and a pad coupled to the terminal end of the elongate member. In some embodiments, the pads of the plurality of feet are extendable and retractable towards and away from the receptacles of the platform. In certain embodiments, the plurality of vibration dampers comprises a plurality of elastomeric elements. In certain embodiments, the platform comprises a first platform of a support platform assembly to which the robotic arm and the sensor unit are mounted, and the support platform assembly comprises a separate and distinct free-standing second platform, wherein the positioner unit is mounted to the second platform. In some embodiments, a first load path is formed which extends from the robotic arm, through the first platform, and to a floor upon which the manufacturing cell is positioned, wherein the second platform is isolated from the first load path, and a second load path is formed which extends from the positioner unit, through the second platform, and to the floor, wherein the first platform is isolated from the second load path.

An embodiment of a method for providing a transportable manufacturing cell comprises (a) mounting a robotic arm of the manufacturing cell to a free-standing first platform of a platform assembly of the manufacturing cell, (b) mounting a sensor unit of the manufacturing cell to the first platform, (c) mounting a positioner unit of the manufacturing cell to a free-standing second platform of the platform assembly which is separate from the first platform, (d) calibrating, with the sensor unit mounted to the first platform and the positioner unit mounted to the second platform, the sensor unit with respect to the positioner unit, and (e) transporting the first platform with the robotic arm mounted thereon, and the second platform with the positioner unit mounted thereon from a first location to a second location that is separate from the first location. In some embodiments, (e) comprises transporting both the first platform and the second platform to the second location using a single vehicle. In some embodiments, the support platform assembly comprises a plurality of feet each having a vibration damper located at a terminal end thereof to dampen vibration between the support platform assembly and the floor. In certain embodiments, the plurality of feet are not anchored to the floor. In certain embodiments, the method comprises (f) applying a first load to the first platform along a first load path extending from the robotic arm, through the first platform, and to a floor upon which the manufacturing cell is positioned, wherein the second platform is isolated from the first load path, and (g) applying a second load to the second platform along a second load path extending from the positioner unit, through the second platform, and to the floor, wherein the first platform is isolated from the second load path.

### BRIEF DESCRIPTION OF THE DRAWINGS

For a detailed description of various exemplary embodiments, reference will now be made to the accompanying drawings in which:

FIG. 1 is front view of an embodiment of a transportable manufacturing cell;

FIG. 2 is a perspective view of the manufacturing cell of FIG. 1;

FIG. 3 is a top view of the manufacturing cell of FIG. 1;

FIG. 4 is a bottom view of the manufacturing cell of FIG. 1;

FIG. 5 is a partial side view of the manufacturing cell of FIG. 1;

FIG. 6 is front view of another embodiment of a transportable manufacturing cell;

FIGS. 7-11 are perspective views of an embodiment of a platform of the manufacturing cell of FIG. 1;

FIG. 12 is a perspective view of another embodiment of a platform; and

FIG. 13 is a flowchart of an embodiment of a method for providing a transportable manufacturing cell.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to...” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As previously described, manufacturing cells may be utilized to leverage robotics in different manufacturing and fabrication processes and may generally include a robotic arm, a positioner for positioning a workpiece operated on by the robotic arm, one or more sensors, a controller, and a platform for physically supporting the components of the manufacturing cell including, for example, the robotic arm, one or more sensors, and the positioner. Conventionally, manufacturing cells are assembled at an off-site manufacturing or fabrication facility. For example, the robotic arm, one or more sensors, controller, and/or positioner may be attached mounted to a support platform of the manufacturing cell whereby the robotic arm, one or more sensors, and positioner are located in a predefined physical arrangement with respect to each other. The platform of the manufacturing cell may also be anchored to a floor of the manufacturing facility via fasteners extending from the floor and secured to the platform. Further, the robotic arm, one or more sensors, and controller may also be connected to a power supply for powering these and/or other components of the manufacturing cell.

Following assembly, at least some of the components of the manufacturing cell such as, for example, the one or more sensors of the cell are calibrated to ensure they function as intended and one or more components of the manufacturing cell may be tested to ensure they function correctly. In this manner, any problems which may potentially interfere with the correct operation of the manufacturing cell (e.g., a faulty robotic arm, a mis-aligned sensor, an incorrectly programmed controller) may be identified before the manufacturing cell is delivered to the end user.

Conventionally, after having been successfully calibrated and tested, the manufacturing cell is disassembled for transport to the site of the end user. Particularly, in many applications, the manufacturing cell is too large and heavy to transport from the manufacturing facility to the site of the end user. For example, the assembled manufacturing cell may be too large to fit within a bed of a pickup truck or similarly sized motor vehicle or even a flatbed truck. Additionally, while larger transport vehicles such as, for example, semi-trailer trucks may be capacious enough to transport the assembled manufacturing cell, the weight of the manufacturing cell may make it difficult and dangerous to load the manufacturing cell onto and from the semi-trailer during transport. For example, the assembled manufacturing cell may be too heavy and cumbersome to lift via conventional fork lifts, potentially prohibiting the manufacturer from loading the manufacturing cell onto the semi-trailer.

To avoid the difficulties outlined above, conventional manufacturing cells are typically disassembled for transport after the successful calibration and testing of the manufacturing cell. For example, the robotic arm, one or more sensors, and/or positioner may be decoupled from the support platform of the manufacturing and transported separately to the site of the end user. Once transported to the end user, the manufacturing cell must again be assembled, calibrated, and tested at the site of the end user to ensure that the reassembled manufacturing cell is ready for operation. Thus, several cumbersome steps must be repeated (assembly, calibration, testing, etc.) at the manufacturing facility and the site of the end user before the manufacturing cell is ready to be brought online for use by the end user. The repletion of these cumbersome steps increases both the costs and time required for providing the end user with the manufacturing cell.

Another difficulty encountered by conventional manufacturing cells is the transmission of vibration and/or shock to sensitive components of the manufacturing cell during operation. For example, the support platform of conventional manufacturing cells is typically anchored to the floor at the site of the end user. Vibration from other equipment or machinery may thus be transmitted through the floor and to the support platform, from where the vibration may be applied to sensitive equipment of the manufacturing cell. The vibration transmitted to the sensitive equipment of the manufacturing cell may disrupt or otherwise hinder operation of the sensitive equipment. For example, excessive vibration transmitted to sensors of the manufacturing cell may reduce the accuracy and/or precision of the sensors, thereby hindering operation of components controlled based on feedback provided by the affected sensors.

Accordingly, embodiments of transportable manufacturing cells are described herein which both provide a modular solution for transporting a partially assembled manufacturing cell from a location at which the manufacturing cell is originally assembled to a second location such as a site of an end user, and for minimizing the amount of vibration and/or shock which is imparted to sensitive components of the manufacturing cell such as sensors and electronics thereof. Specifically, the manufacturing cells described herein include a support platform assembly having multiple separate and distinct free-standing platforms which physically support different components of the manufacturing cell. Additionally, the ability to transport pre-assembled platforms may, in some instances, reduce the extent to which the manufacturing cell must be recalibrated and retested once it has arrived at the second location.

Additionally, each platform is sized to be separately road transportable to the second location without needing to remove the components of the manufacturing cell supported thereon. Particularly, the platforms may be separately transported simply using pickup trucks and similarly sized vehicles instead of the larger and more expensive semi-trailer trucks. Conversely, the platform assembly is sufficiently small and light that it may be transported as a single piece on a flatbed truck. Additionally, the platforms, including the components supported thereon, are light enough to be lifted into the motor vehicle used to transport the platform with a conventional forklift.

In addition to the time and cost savings associated with the modularized platforms of the manufacturing cell, by dividing the platform assembly into multiple platforms vibrations generated by equipment mounted on a first platform may be isolated from equipment mounted on a second platform. For example, a robotic arm and associated sensors may be mounted on a first free-standing platform while a positioner unit, which may be subject to vibration and/or shock as the robotic arm operates on a workpiece held by the positioner unit, is supported on a separate free-standing platform such the first platform is shielded from vibrations transmitted through the second platform.

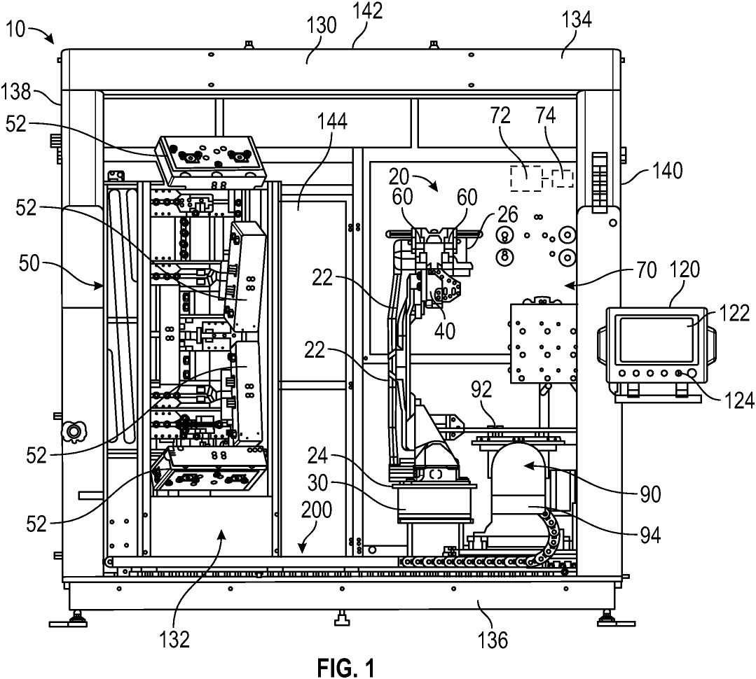

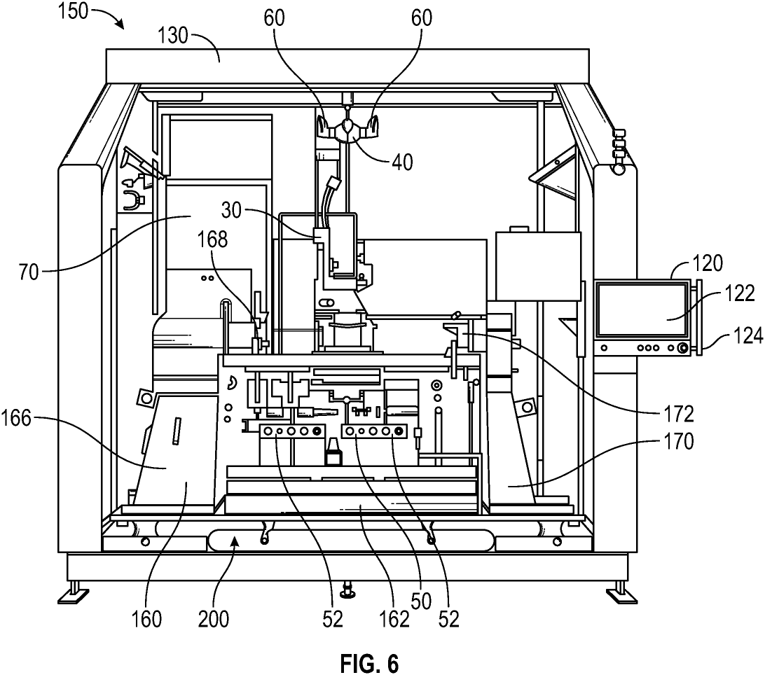

Referring now to FIGS. 1-5, an embodiment of a transportable manufacturing cell 10 including a modular support platform assembly 200 is shown. In this exemplary embodiment, manufacturing cell 10 generally includes a robotic arm 20, a sensor unit 50, a control system or controller 70, a positioner unit 90, an input/output (I/O) unit 120, an enclosure 130, and the support platform assembly 200. It may be understood that the configuration of manufacturing cell 10 may vary in other embodiments, and thus cell 10 may include equipment in addition to that shown in FIGS. 1-5.

The robotic arm 20 of manufacturing cell 10 operates on an object or workpiece positioned or held by the positioner unit 90 of manufacturing cell 10. In this exemplary embodiment, robotic arm 20 generally includes a plurality of articulated arms or links 22 coupled between a base 24 and a terminal end 26 of the robotic arm 20 which is opposite the base 24. Links 22 are pivotably coupled together along the length of robotic arm 20 to provide the terminal end 26 of robotic arm 20 with one or more degrees of freedom (DOF) (e.g., six degrees of freedom (6DOF) in some embodiments) relative to the base 24. For example, links 22 may be coupled end-to-end via a plurality of servos or rotary joints. The base 24 of robotic arm 20 is rotatably attached or mounted to a robot mount 30. Robot mount 30 is connected between robotic arm 20 and the support platform assembly 200 of manufacturing cell 10. In this exemplary embodiment, robotic arm 20 comprises an articulated robotic arm; however, it may be understood that in other embodiments the configuration of robotic arm 20 may vary. For example, in other embodiments, robotic arm 20 may comprise a cartesian robotic arm, a selective compliance assembly robot arm (SCARA), a delta robotic arm, a polar robotic arm, etc.

Additionally, a tool 40 is connected to the terminal end 26 of robotic arm 20 opposite the base 24 thereof. Tool 40 is manipulated by robotic arm 20 to operate on the workpiece held by positioner unit. In this exemplary embodiment, tool 40 comprises a weld head 40 which may be operated to weld the workpiece held by the positioner unit 90. The weld head 40 may perform various types of welding including, for example, seam welding, and may comprise various components for performing welding including a torch and/or other equipment. While in this exemplary embodiment tool 40 comprises a weld head, in other embodiments, various other types of tools may be attached to the terminal end 26 of robotic arm. For example, in other embodiments, tool 40 may comprise a cutting tool, a drill, a gripper, a grinder, and/or other tools.

Sensor unit 50 of manufacturing cell 10 provides sensor feedback to the controller 70 for operating the robotic arm 20, weld head 40, and/or positioner unit 90. Sensor unit 50 may comprise a variety of different types of sensors mounted at various locations for different purposes, and only some of the sensors of sensor unit 50 may be described herein. Particularly, in this exemplary embodiment, sensor unit 50 includes one or more global or workpiece sensors 52, and one or more local or tool sensors 60. Global sensors 52 monitor the workpiece held by positioner unit 90 while local sensors 60 monitor the tool 40 attached to robotic arm 20. For example, global sensors 52 may monitor a position, orientation, condition, surface features, and/or other phenomena associated with the workpiece and/or positioning unit 90. Local sensors 60 may in-turn monitor a position, orientation, condition, and/or other phenomena associated with the tool 40. In this exemplary embodiment, global sensors 52 and/or local sensors 60 comprise optical sensors or cameras (e.g., high frame rate video cameras), positioning sensors, and/or types of sensors.

As described above, the controller 70 of manufacturing cell 10 operates the robotic arm 20, weld head 40, and/or positioner unit 90 using feedback provided by sensor unit 50. Controller 70 generally includes a processor or central processing unit (CPU) and a memory device 74 (each shown schematically in FIG. 1) which stores instructions executable by the CPU 72. It may be understood that CPU 72 may comprise one or more separate processors and memory device 74 may comprise one or more memory devices. Additionally, while controller 70 is shown on-board the support platform assembly 200 of manufacturing cell, it may be understood that in other embodiments at least a portion of the controller 70 may be off-board. For example, in some embodiments, at least some components of the controller 70 may be positioned at a locate remote of the other components of manufacturing cell 10 (e.g., robotic arm 20, positioner unit 90, support platform assembly 200) and may communicate with components of cell 10 via a network.

In some embodiments, controller 70 may operate components of the manufacturing cell 10 autonomously in accordance with instructions stored on the memory device 74. As an example, the CPU 72 of controller 70 may execute a machine learning algorithm including a computer vision algorithm in which the controller 70 autonomously performs a welding operation on a workpiece held by the positioner unit 90 using the robotic arm 20, tool 40, sensor unit 50, and positioner unit 90. Broadly, the controller 70 may autonomously determine a position and orientation of a workpiece to be welded held by the positioner unit 90 using the global sensors 52 of sensor unit 50. Controller 70 may also particularly autonomously identify a seam of the workpiece to be welded using the global sensors 52 of sensor unit 50. Controller 70 may operate the robotic arm 20, tool 40, and/or positioner unit 90 to weld the identified seam using both global sensors 52 and local sensors 60 of sensor unit 50.

As described above, the positioner unit 90 of manufacturing cell 10 positions and/or holds an object or workpiece in a desired position and at a desired orientation. In this exemplary embodiment, positioner unit 90 comprises a positioner 100 extending between a positioner base 102 mounted to the support platform assembly 200 and a connector 104 of the positioner 100. In this exemplary embodiment, base 102 comprises a rotatable mount allowing positioner 100 to rotate about a longitudinal axis thereof relative to the support platform assembly 200. It may be understood that in other embodiments the connection formed between positioner 100 and the support platform assembly 200 by base 102 may vary in configuration. In this exemplary embodiment, the connector 104 comprises a planar stage 104 mounted to the support platform assembly 200. In this exemplary embodiment, one or more workpieces (not shown in FIGS. 1-5) may be positioned on, and potentially secured to, the stage 104 of positioner unit 90.

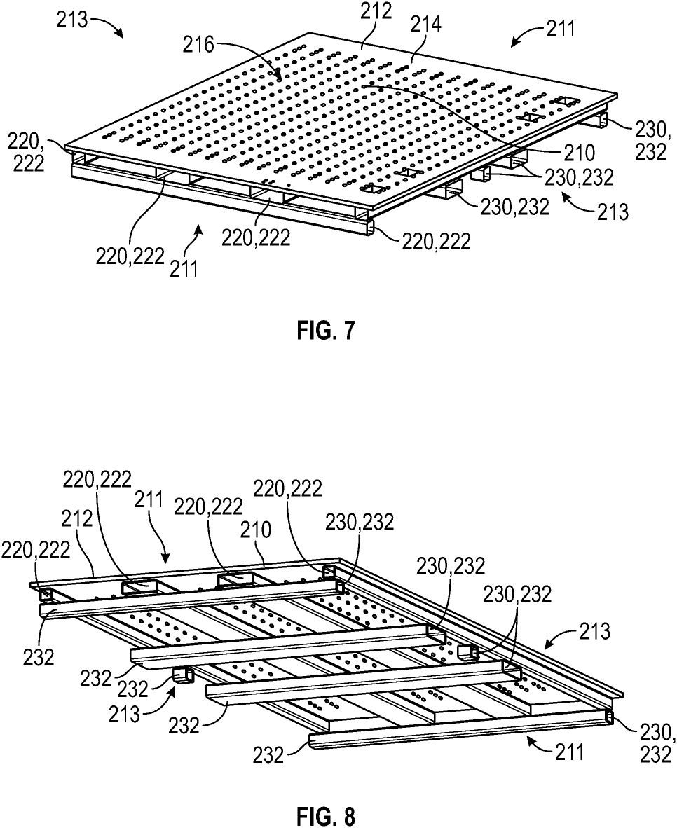

It may be understood that the configuration of positioner unit 90 may vary substantially in other embodiments. For example, and referring briefly to FIG. 6, another embodiment of a manufacturing cell 150 is shown. Manufacturing cell 150 includes features in common with the manufacturing cell 10 shown in FIGS. 1-5, and shared features are labeled similarly. Particularly, in this exemplary embodiment, manufacturing cell 150 is similar to cell 10 except that manufacturing cell 150 includes a positioner unit 160 generally including a support rail 162, a first positioner 166, and a second positioner 170 positioned opposite the first positioner 166. First positioner 166 comprises a first connector 168 for gripping or holding a first end of a workpiece, and second positioner 170 comprises a second connector 172 for gripping or holding a second end of the workpiece, opposite the first end. Connectors 168, 172 may be rotatable via a pair of servo motors or rotary actuators to provide for the rotation of a workpiece about a longitudinal axis of the workpiece. Positioners 166, 170 may be transported along support rail 162 to accommodate differently sized workpieces. While the stage 104 of the positioner unit 90 described above is sized to accommodate relatively small or compact components positionable on the stage 104, positioner unit 160 of manufacturing cell 150 may accommodate relatively long, elongate workpieces which extend between the positioners 166, 170 of positioner unit 160. Thus, manufacturing cell 150 illustrates that the configuration of the positioner unit of a given manufacturing cell may vary substantially to accommodate different types of workpieces and/or to provide different types movement of the workpiece relative to the platform assembly 200.

Referring again to FIGS. 1-5, the controller 70 may operate operates the robotic arm 20, weld head 40, and/or positioner unit 90 based on command inputs provided to the controller 70 by an operator of manufacturing cell 10 using the I/O unit 120 of cell 10. For example, the operator of manufacturing cell 10 may input a command to the I/O unit 120 to initiate a desired operational sequence executable by the controller 70 to weld or otherwise operate on a workpiece held by the positioner unit 90 of the manufacturing cell 10. In this exemplary embodiment, I/O unit 120 comprises a display 122 and an input (e.g., a keypad or other input) 124 from which an operator may both input command signals to the controller 70 and monitor an operational status of the manufacturing cell 10. In some embodiments, the operator of manufacturing cell 10 may directly control the operation of components of cell 10 including, for example, robotic arm 20, tool 40, sensor unit 50, and/or positioner unit 90.

The enclosure 130 encloses or houses components of manufacturing cell 10 such as robotic arm 20, sensor unit 50, controller 70, and positioner unit 90. In this manner, enclosure may protect components of manufacturing cell 10 from hazards from the environment surrounding manufacturing cell 10 while still providing external access to the components of manufacturing cell 10. In this exemplary embodiment, enclosure 130 comprises a plurality of panels supported by platform assembly 200 and which define a front opening 132 which provides access to internal components of manufacturing cell 10. For example, an operator of manufacturing cell 10 may insert and/or retrieve a workpiece from the positioner unit 90 of manufacturing cell 10 via the front opening 132 defined by enclosure 130. In this exemplary embodiment, enclosure 130 generally includes a pair of elongate front panels 134, 136, a pair of side panels 138, 140, a top panel 142, and a rear panel 144. It may be understood that the configuration of enclosure 130 may vary in other embodiments and, indeed, in some embodiments the manufacturing cell 10 may not include an enclosure.

As described above, platform assembly 200 physically supports components of manufacturing cell 10 including, for example, robotic arm 20, sensor unit 50, controller 70, positioner unit 90, and enclosure 130. Particularly, platform assembly 200 transfers loads from the components of manufacturing cell 10 such as, for example, loads due to the weight of the components and/or dynamic loads resulting from the operation of robotic arm 20, positioner unit 90. Additionally, as will be described further herein, platform assembly 200 provides a modular solution whereby manufacturing cell 10 may be broken down into modular units for transportation without needing to disassemble major components of the manufacturing cell (e.g., robotic arm 20, sensor unit 50, controller 70, and/or positioner unit 90) from the platform assembly 200, thereby avoiding the requirement of recalibrating and retesting manufacturing cell 10 once it has arrived at the site of the end user. Additionally, platform assembly 200 is specifically configured to isolate or at least attenuate vibration and/or shock imparted to sensitive components of manufacturing cell 10 such as, for example, sensor unit 50, controller 70, etc. during operation of manufacturing cell 10.

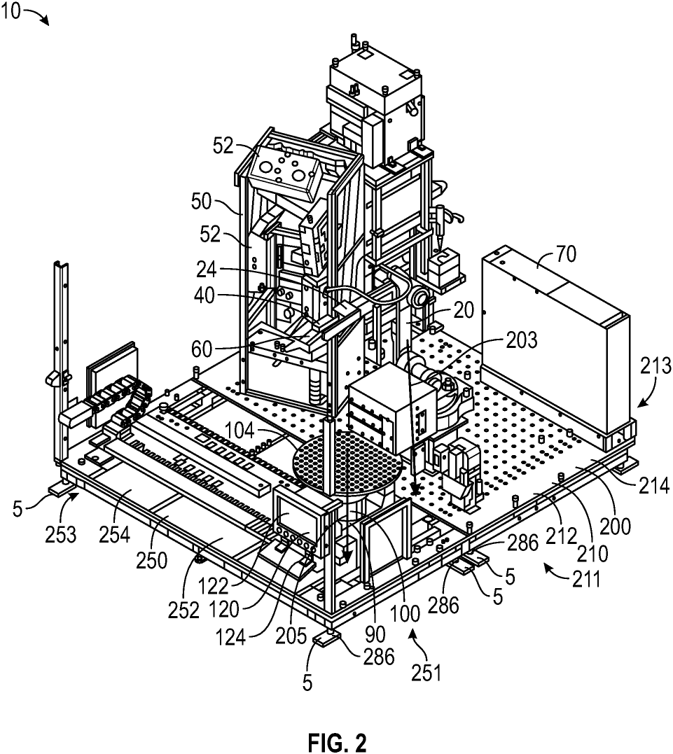

In this exemplary embodiment, platform assembly 200 generally includes a free-standing first or primary platform 210 and a free-standing second or secondary platform 250. Primary platform 210 may also be referred to herein as master platform 210 and secondary platform 250 may also be referred to herein as accessory platform 250 or positioner platform 250. Secondary platform 250 stands freely from the first platform 210 such that neither platform 210, 250 is dependent on the other for supporting the components mounted thereon. Particularly, platforms 210, 250 are each separately free-standing such that loads imparted to platforms 210, 250 (with the possible exception of loads transferred from enclosure 130) are not transferred directly between platforms 210, 250. Indeed, with the possible exception of enclosure 130, platforms 210, 250 may not be directly connected together (e.g., via a connector extending from the primary platform 210 to the secondary platform 250) following the assembly of manufacturing cell 10. As an example, and shown particularly in FIG. 2, a first load path 203 may extend from the robotic arm 20, through the first platform 210, and to the floor upon which the manufacturing cell 10 is positioned, where the secondary platform 250 is isolated from the first load path 203. Additionally, a second load path 205 may extend from the positioner unit 90, through the second platform 250, and to the floor upon which the manufacturing cell 10 is positioned, where the first platform 210 is isolated form the second load path 205.

In this manner, platforms 210, 250 may be transported separately without needing to remove the components (again, with the possible exception of enclosure 130) supported thereon given that the size and weight of each platform and its associated components is substantially less than the size and weight of the fully assembled manufacturing cell 10. For example, in some embodiments, platforms 210, 250 are sized to fit on a cargo box or “bed” of a pickup truck for road transportation, avoiding the need for semi-trailer truck transport. Additionally, platforms 210, 250 may be sized such that platform assembly 200 may be transported as a single unit in the bed of a flatbed truck. As an example, in some embodiments, each platform 210, 250 may be approximately 5 feet (ft) by 10 ft in size; however, it may be understood that the size of platforms 210, 250 may vary in different embodiments. Additionally, in some embodiments, the weight of each assembled platform 210, 250 (including associated components of manufacturing cell 10 mounted thereon) is less than 6,000 pounds, making each assembled platform 210, 250 liftable by conventional forklifts and transportable in the bed of a truck or trailer.

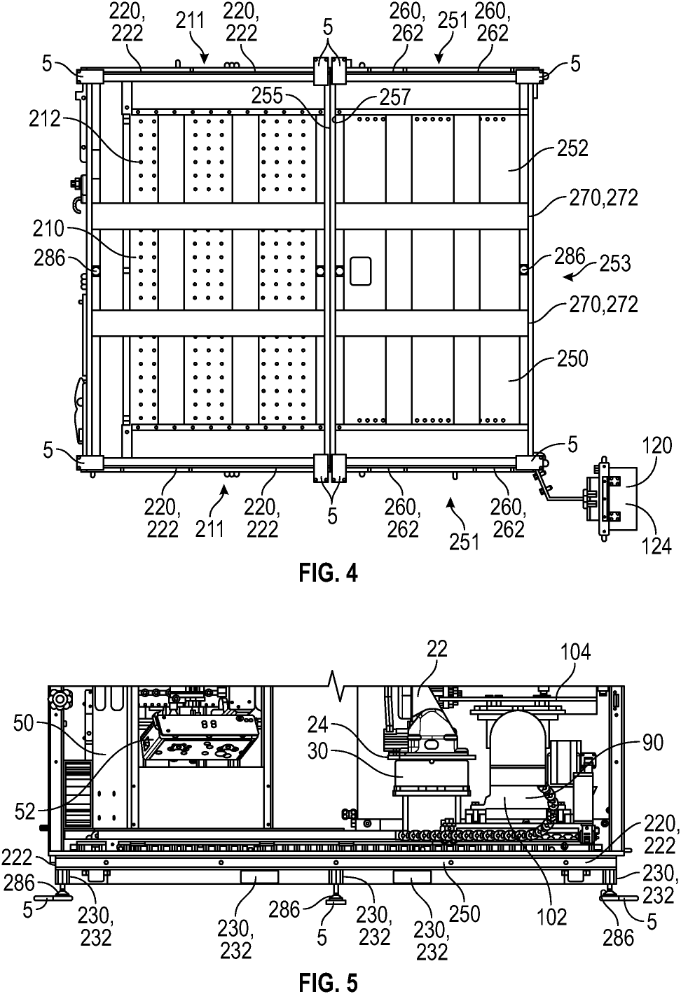

In addition to avoiding the need of removing components from platforms 210, 250 for transportation, the separated platforms 210, 250 also mitigate the transfer of forces including vibration, shock, etc., therebetween. Particularly, in this exemplary embodiment, the robotic arm 20, sensor unit 50, and controller 70 are each supported on the primary platform 210 while the positioner unit 90 is supported on the secondary platform 250. During operation of manufacturing cell 10, positioner unit 90 may experience elevated vibration as the workpiece held by the positioner unit 90 is operated on by the tool 40 conveyed by robotic arm 20. In conventional manufacturing cells having only a single platform supporting both sensitive electronics and a positioner unit, this vibration would be transmitted through the platform to the sensitive electronics, potentially damaging or otherwise interfering with the operation of the electronics. However, in this instance, vibration from positioner unit 90 may not generally be transferred directly from the secondary platform 250 to the primary platform 210 given that platforms 210, 250 are separate and free-standing. Indeed, in some embodiments, platforms 210, 250 are separated by a small gap 255 (shown in FIG. 4) along an interface 257 to prevent secondary platform 250 from transmitting vibration (e.g., chattering against or otherwise physically contacting platform 210) directly to the primary platform 210. Instead, vibration is transferred from the positioner unit 90 to the floor via the secondary platform 250.

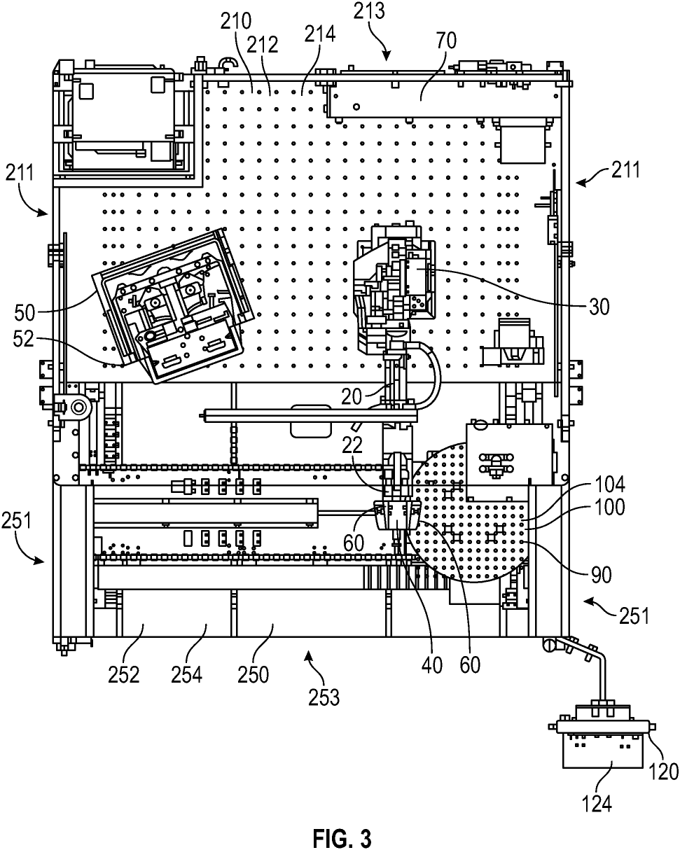

Referring now to FIGS. 3-11, additional views of the primary platform 210 are shown. It may be understood that platforms 210, 250 share at least some similar features. Indeed, in some embodiments, platforms 210, 250 may be configured identically. However, in other embodiments, the configuration of primary platform 210 may vary from the configuration of secondary platform 250 based on the requirements of the given application. Additionally, while platforms 210, 250 are shown in FIGS. 3-11 as having a rectangular shape, it may be understood that in other embodiments the shape of platforms 210, 250 may vary.

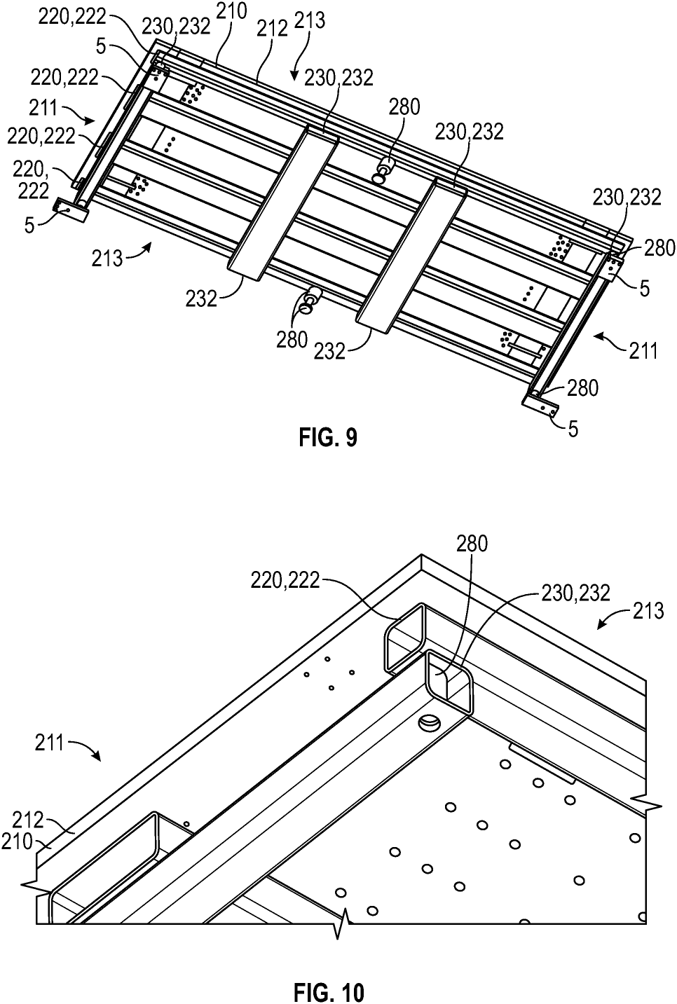

Each platform 210, 250 of support platform assembly 200 has a pair of opposed longitudinal ends 211, 251, respectively, and a pair of opposing lateral ends 213, 253, respectively. In this exemplary embodiment, each platform 210, 250 includes a support plate 212, 252, respectively, which defines an upper support surface 214, 254, respectively, of the support platform 210, 250. The components supported on the platforms 210, 250 may be directly attached to the upper support surface 214, 254, respectively, thereof. For example, the robot mount 30 attached to robotic arm 20 may be mounted directly to the upper support surface 214 of primary platform 210. In this exemplary embodiment, support plate 212 includes a plurality of apertures or mounting holes (indicated generally by arrow 216 in FIG. 7) to facilitate the mounting of equipment to primary platform 210. It may be understood that upper support surfaces 214, 254 of platforms 210, 250 may comprise a variety of features to facilitate the coupling formed between platform 210 and the equipment mounted thereto. Such features may include features to allow for couplings which permit rotational and/or linear movement between the equipment and the platform 210, 250.

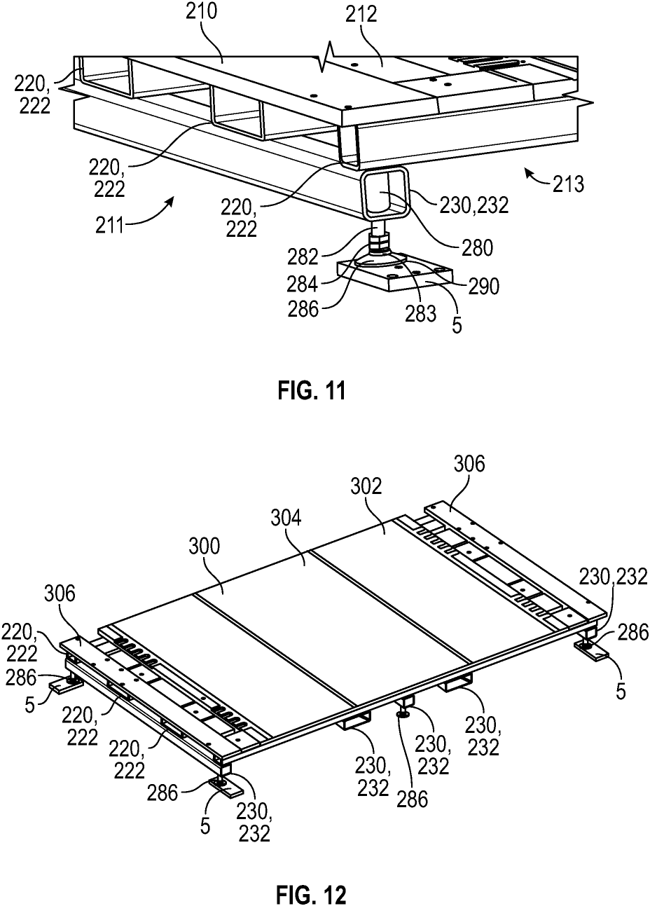

As an example, referring briefly to FIG. 12, alternative embodiment of a support platform 300 is shown. Platform 300 includes features in common with platforms 210, 250, and shared features are labeled similarly. Particularly, in this exemplary embodiment, platform 300 includes a support plate 302 which defines an upper support surface 304. In this exemplary embodiment, platform 300 includes a pair of support rails 306 positioned on the upper surface 304 and extending along opposed longitudinal ends of the platform 300. Moveable equipment may be mounted to support rails 306 such that the equipment may be transported along the given rail 306. For example, a robotic arm may be mounted to one of the support rails 306 and may be transported along the rail 306 (e.g., via a linear actuator) between a plurality of positions located along the rail 306. Alternatively, a positioner unit may be arm may be mounted to one of the support rails 306 and may be transported along the rail 306.

Referring again to FIGS. 3-11, in this exemplary embodiment, platforms 210, 250 additionally include a plurality of first support tubes 220, 260, respectively, and a plurality of second support tubes 230, 270, respectively. First support tubes 220 are positioned and coupled between the support plate 212 of primary platform 210 and the second support tubes 230. Similarly, first support tubes 220 are positioned and coupled between the support plate 252 of secondary platform 250 and the second support tubes 270. However, it may be understood that in other embodiments the second support tubes 230 of primary platform 210 may be coupled between support plate 212 and first support tubes, and the second support tubes 270 of secondary platform 250 may similarly be coupled between support plate 252 and first support tubes 220. Additionally, it may be understood that in other embodiments platforms 210, 250 may only include support plates 212, 252 and may not include the first support tubes 220, 260 and/or second support tubes 230, 270. Alternatively, in some embodiments, platforms 210, 250 may not include support plates 212, 252 and may only include first support tubes 220, 260 and/or second support tubes 230, 270.

In this exemplary embodiment, first support tubes 220, 270 and second support tubes 230, 270 each comprise tubular steel or tube steel members having a generally rectangular cross-section; however, it may be understood that the cross-sectional shape and materials forming the first support tubes 220, 270 and second support tubes 230, 270 may vary in other embodiments.

First support tubes 220, 260 extend longitudinally along platforms 210, 250, respectively, such that opposing ends of each first support tube 220, 260 is located at a corresponding longitudinal end 211, 251, respectively, of the platform 210, 250. In this arrangement, the ends of first support tubes 220, 260 are spaced along the longitudinal ends 211, 251, respectively, of platforms 210, 250. For example, an outer pair of the first support tubes 220, 260 are positioned along the lateral ends 213, 253, respectively, of platforms 210, 250 while an inner pair of the first support tubes 220, 260 are spaced from the lateral ends 213, 253, respectively, of platforms 210, 250. It may be understood that the positioning of first support tubes 220, 260 along the longitudinal ends 211, 251, respectively, of platforms 210, 250 may vary in other embodiments.

The size or diameter of first support tubes 220 may vary from each other with the outer pair of first support tubes 220 having a smaller width than the inner pair of first support tubes 220. Similarly, the size or diameter of first support tubes 220 may vary from each other with the outer pair of first support tubes 220 having a smaller width than the inner pair of first support tubes 220. It however may be understood that the relative sizes of first support tubes 220 and the relative sizes of first support tubes 220 may vary in other embodiments. In this exemplary embodiment, the opposing ends of first support tubes 220, 260 each define an opening 222, 262, respectively, of the first support tube 220, 260.

Conversely, second support tubes 230, 270 extend laterally across platforms 210, 250, respectively, such that opposing ends of each second support tube 230, 270 is located at a corresponding lateral end 213, 253, respectively, of the platform 210, 250. In this arrangement, the ends of second support tubes 230, 270 are spaced along the lateral ends 213, 253, respectively, of platforms 210, 250. For example, an outer pair of the second support tubes 230, 270 are positioned along the longitudinal ends 211, 251, respectively, of platforms 210, 250 while an inner pair of the second support tubes 230, 270 are spaced from the longitudinal ends 211, 251, respectively, of platforms 210, 250. Additionally, in this exemplary embodiment, each of the plurality of second support tubes 230, 270 include a pair of central second support tubes 230, 270 which do not extend entirely between the lateral ends 213, 253, respectively, of platforms 210, 250, and instead, are truncated in length. It may be understood that the positioning of second support tubes 230, 270 along the lateral ends 213, 253, respectively, of platforms 210, 250 may vary in other embodiments.

The size or diameter of second support tubes 270 may vary from each other with the outer pair of second support tubes 270 having a smaller width than the inner pair of second support tubes 270. Similarly, the size or diameter of second support tubes 270 may vary from each other with the outer pair of second support tubes 270 having a smaller width than the inner pair of second support tubes 270. It however may be understood that the relative sizes of second support tubes 270 and the relative sizes of second support tubes 270 may vary in other embodiments. In this exemplary embodiment, the opposing ends of second support tubes 230, 270 each define an opening 232, 272, respectively, of the second support tube 230, 270.

The openings 222, 262 of at least some of the first support tubes 220, 260, respectively, are sized to receive a fork of a conventional forklift such that the forklift may conveniently interface and couple with the platform 210, 250 via the openings 222, 262 of the first support tubes 220, 260. Similarly, the openings 232, 272 of at least some of the second support tubes 230, 270, respectively, are sized to receive a fork of a conventional forklift such that the forklift may interface and couple with the platform 210, 250 via the openings 232, 272 of the second support tubes 230, 270. Given that openings 222, 262 of platforms 210, 250 are positioned along each longitudinal end 211, 251, and openings 232, 272 of platforms 210, 250, respectively, are positioned along each lateral end 213, 253, a conventional forklift may couple with a platform 210, 250 via either of the longitudinal ends 211, 251 and either of the lateral ends 213, 253 of the platform 210, 250.

For example, a conventional forklift may approach a longitudinal end 211 of a primary platform 210, insert the pair of forks into openings 222 of a pair of first support tubes 220 of the primary platform 210 to couple the forklift with the primary platform 210 whereby the forklift may vertically raise the primary platform 210 (including the equipment mounted thereto including robotic arm 20, sensor unit 50, etc.) and position the primary platform 210 in a bed of a pickup truck for transport to the site of an end user. Similarly, the conventional forklift may approach a lateral end 213 of a primary platform 210, insert the pair of forks into openings 232 of a pair of second support tubes 230 of the primary platform 210 to couple the forklift with the primary platform 210 whereby the forklift may vertically raise the primary platform 210 and position the primary platform 210 in a bed of a pickup truck for transport to the site of an end user. In this manner, the platforms 210, 250 may be arranged as is convenient at the facility at which platforms 210, 250 are assembled such that only one of the longitudinal ends 211, 251, or one of the lateral ends 213, 253 of the platforms 210, 250, respectively, is accessible for a conventional forklift. In some embodiments, a pair of conventional forklifts may be used to pick up both platforms 210, 250 of platform assembly 200 as a single unit and position the platform assembly 200 in the bed of a flatbed truck.

As described above, support platform assembly 200 of manufacturing cell 10 is not anchored to the floor upon which it is positioned and instead is permitted to “float” on the floor. Particularly, there are no fasteners, rivets, welds, or other types of connectors used to attach the support platform assembly 200 to the floor, and instead, assembly 200 is loosely sat or positioned on the floor.

Support platform assembly 200 is positioned on the floor using a plurality of feet 275, one of which is shown particularly in FIG. 11. In this exemplary embodiment, each foot 275 generally includes a receptacle 280, an elongate member or rod 282 extending from the receptacle 280, a pad 286 secured to a terminal end 283 of the rod 282, and a lock 284 positioned on the rod 282. Receptacles 280 are secured within the openings 232, 272 of at least some of the second support tubes 230, 270 of platforms 210, 250, respectively. In some embodiments, receptacles 280 are internally threaded to thereby threadably connect with rods 282 which may be correspondingly externally threaded along at least a portion of each rod 282.

In this exemplary embodiment, lock 284 comprises a pair of internally threaded nots which may selectably restrict relative rotation between the rod 282 and the receptacle 280. Particularly, each foot 275 includes an unlocked configuration in which rod 282 is permitted to rotate relative to the receptacle 280 and thereby longitudinally extend or retract from the receptacle 280, and a locked configuration in which the nuts of lock 284 lock rotation of the rod 282 relative to the receptacle 280. Rods 282 may be selectably extended from and retracted into receptacle 280 to level and/or adjust a vertical height of the platform to which the foot 275 is attached.

In this exemplary embodiment, each foot 275 additionally includes a vibration damper 290 (shown in FIG. 11) integrated into the pad 286 of the foot 275 such that the vibration damper 290 defines a terminal end of the pad 286. In this arrangement, the vibration dampers 290 are positioned between feet 275 and the floor whereby the vibration damper 290 dampens or attenuates vibration received by the foot 275 from the floor. For example, vibration dampers 290 may comprise elastomeric members or pads which may be adhered or otherwise attached to the pads 286. In this exemplary embodiment, vibration dampers 290 reduce the amount of vibration received by the components mounted to the platforms 210, 250, including the sensor unit 50 and controller 70 mounted to the primary platform 210 such that the vibration does not damage or otherwise interfere with the operation of the sensor unit 50 and controller 70. Further, the pads 286 may be positioned on leveling feet 5 (which are separate from the feet 275) at the site of the end user to ensure that platform assembly 200 is leveled on the floor.

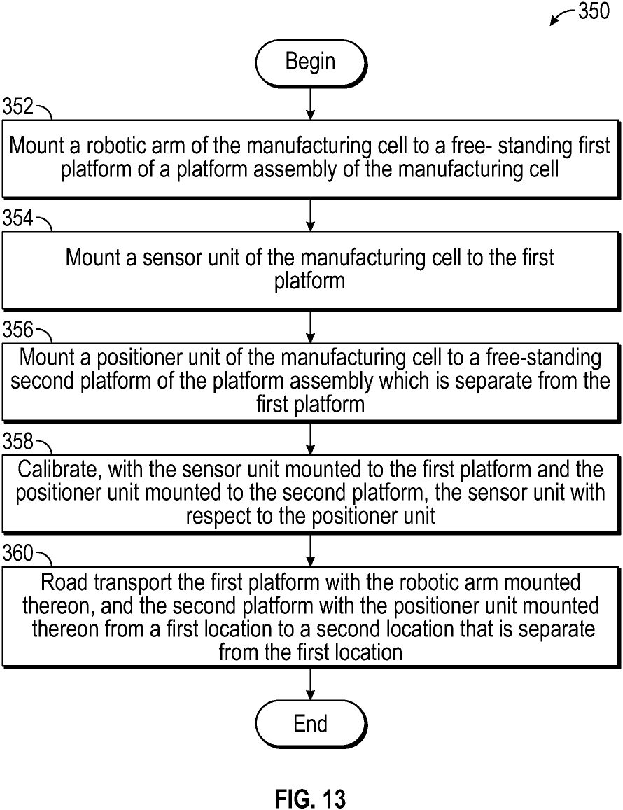

Referring to FIG. 13, a method 350 for providing a transportable manufacturing cell is shown. In this exemplary embodiment, method 350 begins at block 352 which comprises mounting a robotic arm of the manufacturing cell to a free-standing first platform of a platform assembly of the manufacturing cell. In some embodiments, block 352 comprises mounting the robotic arm 20 of the manufacturing cell 10 shown in FIGS. 1-5 with the primary platform 210 of the support platform assembly 200. For example, block 352 may comprise mounting (e.g., via a plurality of fasteners) the robot mount 30 to the upper support surface 214 of primary platform 210 and coupling the base 24 of robotic arm 20 to the robot mount 30.

Block 354 of method 350 comprises mounting a sensor unit of the manufacturing cell to the first platform. In some embodiments, block 354 comprises mounting the sensor unit 50 to the primary platform 210. For example, block 354 may comprise mounting the global sensors 52 of sensor unit 50 to the upper support surface 214 (e.g., via a plurality of fasteners) of the primary platform 210. Block 356 of method 350 comprises mounting a positioner unit of the manufacturing cell to a free-standing second platform of the platform assembly which is separate from the first platform. In some embodiments, block 356 comprises mounting the positioner unit 90 shown in FIGS. 1-5 to the secondary platform 250 of support platform assembly 200. For example, block 356 may comprise mounting the base 102 of the positioner 100 to the upper support surface 254 of the secondary platform 250 (e.g., via one or more fasteners).

Block 358 of method 350 comprises calibrating, with the sensor unit mounted to the first platform and the positioner unit mounted to the second platform, the sensor unit with respect to the positioner unit. In some embodiments, block 358 comprises calibrating one or more sensors of the sensor unit 50 shown in FIGS. 1-5 including, for example, global sensors 52 and local sensors 60 to ensure the proper functioning of sensors 52, 60 during operation of the manufacturing cell 10.

Block 360 of method 350 comprises road transporting the first platform with the robotic arm mounted thereon, and the second platform with the positioner unit mounted thereon from a first location to a second location that is separate from the first location. In some embodiments, block 360 comprises road transporting the primary platform 210 (having the robotic arm 20 and sensor unit 50 mounted thereto) and road transporting the secondary platform 250 (having the positioner unit 90 mounted thereto) from the first location to the second location. It may be understood that the first location may comprise two separate locations from which the primary platform 210 and second platform 250 are separately transported to the second location which may, in some embodiments, comprise a site of an end user of the manufacturing cell 10. Primary platform 210 and secondary platform 250 may be road transported in the bed of a single flatbed truck or in the beds of separate pickup trucks or similar motor vehicles from the first location to the second location.

For example, in some embodiments, the support platform assembly 200 may already be assembled at the first location such that the secondary platform 250 is positioned adjacent the primary platform 210, and the assembled support platform assembly 200 may be transported as a single unit to the second location. In some embodiments, the secondary platform 250 is positioned adjacent the primary platform 210 such that a predefined gap is formed along an interface which extends entirely between the platforms 210, 250. For example, the gap may extend between adjacently positioned lateral ends 213, 253, respectively, of the platforms 210, 250.

Alternatively, the platforms 210, 250 of support platform assembly 200 may be transported separately where the primary platform and secondary platform 250 are separately lifted using a conventional forklift into the beds of the pickup trucks used to transport the platforms 210, 250. Upon delivery to the second location, the manufacturing cell 10 may be assembled at the second location (e.g., a site of an end user of the cell 10) such that the secondary platform 250 is positioned adjacent the primary platform 210.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A transportable manufacturing cell, comprising:
a robotic arm extending between a base and a terminal end;
a tool attached to the terminal end of the robotic arm;
a positioner unit comprising a positioner extending between a base and a connector, the connector configured to secure a workpiece to the positioner;
a sensor unit comprising one or more sensors;
a controller configured to control the operation of the robotic arm and the tool attached to the robotic arm; and
a support platform assembly comprising a free-standing first platform and a separate and distinct free-standing second platform, wherein the robotic arm and the sensor unit are each mounted to the first platform and the positioner unit is mounted to the second platform.

2. The manufacturing cell of claim 1, wherein the second platform is separated from the first platform by a predefined gap extending across an interface that extends between the first platform and the second platform.

3. The manufacturing cell of claim 1, wherein:
the first platform comprises a planar support plate having an upper support surface to which the base of the robotic arm is mounted; and
the second platform comprises a support plate having an upper support surface to which the base of the base of the positioner is mounted.

4. The manufacturing cell of claim 3, wherein at least one of the first platform comprises a support rail positioned on the upper support surface of the support plate of the first platform, and the second platform comprises a support rail positioned on the upper support surface of the support plate of the second platform.

5. The manufacturing cell of claim 1, wherein:
the first platform comprises a first plurality of parallel first support tubes each having an opening positioned at an end of the first platform; and
the second platform comprises a second plurality of parallel first support tubes each having an opening positioned at an end of the second platform.

6. The manufacturing cell of claim 5, wherein:
the first platform comprises a first plurality of parallel second support tubes each having an opening positioned at an end of the first platform, and wherein each of the first plurality of second support tubes is oriented perpendicular to the first plurality of first support tubes; and
the second platform comprises a second plurality of parallel second support tubes each having an opening positioned at an end of the second platform, and wherein each of the second plurality of second support tubes is oriented perpendicular to the second plurality of first support tubes.

7. The manufacturing cell of claim 1, wherein the tool comprises a weld head, and the controller is configured to autonomously weld the workpiece using the robotic arm.

8. The manufacturing cell of claim 1, wherein:
the first platform comprises a first plurality of feet extending from the first platform and a first plurality of vibration dampers located at terminal ends of the first plurality of feet; and
the second platform comprises a second plurality of feet extending from the second platform and a second plurality of vibration dampers located at terminal ends of the second plurality of feet.

9. The manufacturing cell of claim 1, wherein:
a first load path is formed which extends from the robotic arm, through the first platform, and to a floor upon which the manufacturing cell is positioned, wherein the second platform is isolated from the first load path; and
a second load path is formed which extends from the positioner unit, through the second platform, and to the floor, wherein the first platform is isolated from the second load path.

10. A transportable manufacturing cell, comprising:
a robotic arm extending between a base and a terminal end;
a tool attached to the terminal end of the robotic arm;
a positioner unit comprising a positioner extending between a base and a connector configured to secure a workpiece to the positioner;
a sensor unit comprising one or more sensors;
a controller configured to control the operation of the robotic arm and the tool attached to the robotic arm; and
a support platform assembly comprising a free-standing platform to which at least one of the robotic arm, the sensor unit, and the positioner unit is mounted, the platform comprising a plurality of feet extending from the platform and a plurality of vibration dampers located at terminal ends of the plurality of feet.

11. The manufacturing cell of claim 10, wherein each of the plurality of feet comprises an elongate member extending from one of a plurality of receptacles formed in the platform to a terminal end, and a pad coupled to the terminal end of the elongate member.

12. The manufacturing cell of claim 11, wherein the pads of the plurality of feet are extendable and retractable towards and away from the receptacles of the platform.

13. The manufacturing cell of claim 10, wherein the plurality of vibration dampers comprises a plurality of elastomeric elements.

14. The manufacturing cell of claim 10, wherein:
the platform comprises a first platform of a support platform assembly to which the robotic arm and the sensor unit are mounted; and
the support platform assembly comprises a separate and distinct free-standing second platform, wherein the positioner unit is mounted to the second platform.

15. The manufacturing cell of claim 14, wherein:
a first load path is formed which extends from the robotic arm, through the first platform, and to a floor upon which the manufacturing cell is positioned, wherein the second platform is isolated from the first load path; and
a second load path is formed which extends from the positioner unit, through the second platform, and to the floor, wherein the first platform is isolated from the second load path.

16. A method for providing a transportable manufacturing cell, the method comprising:
(a) mounting a robotic arm of the manufacturing cell to a free-standing first platform of a platform assembly of the manufacturing cell;
(b) mounting a sensor unit of the manufacturing cell to the first platform;
(c) mounting a positioner unit of the manufacturing cell to a free-standing second platform of the platform assembly which is separate from the first platform;
(d) calibrating, with the sensor unit mounted to the first platform and the positioner unit mounted to the second platform, the sensor unit with respect to the positioner unit; and
(e) transporting the first platform with the robotic arm mounted thereon, and the second platform with the positioner unit mounted thereon from a first location to a second location that is separate from the first location.

17. The method of claim 16, wherein (e) comprises transporting both the first platform and the second platform to the second location using a single vehicle.

18. The method of claim 16, wherein the support platform assembly comprises a plurality of feet each having a vibration damper located at a terminal end thereof to dampen vibration between the support platform assembly and the floor.

19. The method of claim 18, wherein the plurality of feet are not anchored to the floor.

20. The method of claim 16, further comprising:
(f) applying a first load to the first platform along a first load path extending from the robotic arm, through the first platform, and to a floor upon which the manufacturing cell is positioned, wherein the second platform is isolated from the first load path; and
(g) applying a second load to the second platform along a second load path extending from the positioner unit, through the second platform, and to the floor, wherein the first platform is isolated from the second load path.
